(19) United States
(12) Patent Application Publication
(10) Pub. No.: US 2005/0133072 A1
(43) Pub. Date: Jun. 23, 2005

(54) Device for supplying washing water in dish washer

(75) Inventors: Sang Heon Yoon, Seoul (KR); Nung Seo Park, Incheon (KR); Dae Yeong Han, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/865,745

(22) Filed: Jun. 14, 2004

(30) Foreign Application Priority Data
Dec. 19, 2003 (KR) P2003-93826

(51) Int. Cl. B08B 3/00

(52) U.S. Cl. 134/58 D; 134/111; 134/186; 134/200

(57) ABSTRACT

Device for supplying washing water to a dish washer including a sump for holding washing water, a filtering housing for guiding a portion of the washing water pumped up by a pump from the sump to a spray arm in a washing chamber, and holding rest of the washing water therein, and a filtering panel including a filter portion for filtering the washing water overflowed from the filtering housing by using at least two filters having filtering capabilities different from each other, and apertures for guiding the washing water dropped after washing the dishes in the washing chamber, or passed through the filter portion.

This application claims the benefit of the Korean Application No. P2003-0093826 filed on Dec. 19, 2003, which is hereby incorporated by reference.

### BACKGROUND OF THE INVENTION

1. Field of the Invention

The present invention relates to dish washers, and more particularly, to a device for filtering, and supplying washing water to a spray arm.

2. Background of the Related Art

The dish washer automatically washes, and dries dishes by spraying detergent and washing water to the dishes. In general, the dish washer is provided with racks for placing the dishes thereon, a sump for holding the washing water, spray arms for spraying the washing water to the dishes on the racks, and a motor for supplying the washing water from the sump to the spray arm.

In the operation, upon putting the motor into operation, the spray arm sprays the washing water in the sump to the dishes, to wash the dishes. The washing water sprayed to the dishes returns to the sump again, and sprayed to the dishes again.

Consequently, the washing water in the sump is gradually contaminated. Continuous use of heavily contaminated washing water, not only drops washing capability, but also is liable to block a passage of the washing water.

In order to prevent this, it is required to change the washing water periodically, too frequent change of the washing water may consume too much washing water.

### SUMMARY OF THE INVENTION

Accordingly, the present invention is directed to a device for supplying washing water in a dish washer that substantially obviates one or more of the problems due to limitations and disadvantages of the related art.

An object of the present invention lies on effective filtering and supplying washing water in a dish washer to a spray arm.

Another object of the present invention lies on preventing wasting of washing water at a dish washer.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the device for supplying washing water to a dish washer includes a sump for holding washing water, a filtering housing for guiding a portion of the washing water pumped up by a pump from the sump to a spray arm in a washing chamber, and holding rest of the washing water therein, and a filtering panel including a filter portion for filtering the washing water overflowed from the filtering housing by using at least two filters having filtering capabilities different from each other, and apertures for guiding the washing water dropped after washing the dishes in the washing chamber, or passed through the filter portion.

In other aspect of the present invention, there is provided a dish washer including a cabinet having a washing chamber therein, at least a spray arm for spraying high pressure washing water to dishes in the washing chamber, and a device for supplying washing water to a dish washer including a sump for holding washing water, a filtering housing for guiding a portion of the washing water pumped up by a pump from the sump to a spray arm in a washing chamber, and holding rest of the washing water therein, and a filtering panel including a filter portion for filtering the washing water overflowed from the filtering housing by using at least two filters having filtering capabilities different from each other, and apertures for guiding the washing water dropped after washing the dishes in the washing chamber, or passed through the filter portion.

The filtering housing includes a guide passage for making the pump and the spray arm in communication, and a contaminated water chamber in communication with the pump, for holding the rest portion of the washing water.

The filtering panel covers an upper portion of the filtering housing.

The filter portion includes at least one first filter on the filtering housing, and a second filter on the filtering housing which is coarser than the first filter.

The contaminated water chamber includes an inlet being through which the washing water is introduced into an inside of the contaminated water chamber and a drain for draining the washing water from the contaminated water chamber selectively.

The first filter is arranged adjacent to the drain, and the second filter is arranged adjacent to the inlet. The second filter is arranged at a position higher than the first filter.

The filer portion includes at least one of a net and a perforated portion. Particularly, the second filter includes a perforated portion or a net formed in the filtering panel.

It is to be understood that both the foregoing description and the following detailed description of the present invention are exemplary and explanatory and are intended to provide further explanation of the invention claimed.

### BRIEF DESCRITPION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a diagram showing a structure of a dish washer of the present invention, schematically;

FIG. 2 illustrates a disassembled perspective view of a device for supplying washing water in accordance with a preferred embodiment of the present invention;

FIG. 3 illustrates a section of the device for supplying washing water in FIG. 2;

FIG. 4 illustrates a section showing a washing water flow in a filtering housing in the device for supplying washing water in FIG. 2;

FIG. 5 illustrates a disassembled perspective view showing washing water filtering by overflow from a filtering housing in the device for supplying washing water in FIG. 2;

FIG. 6 illustrates a disassembled perspective view of a filtering panel, and a filtering housing of another embodiment of the device for supplying washing water in FIG. 1;

FIG. 7 illustrates a disassembled perspective view showing washing water filtering by overflow from a filtering housing in FIG. 6; and

FIG. 8 illustrates a disassembled perspective view showing a large amount of washing water is filtered through a second filter in a case contaminants are stuck to a first filter of the filtering panel in FIG. 6.

### DETAILED DESCRIPTION OF THE PREFERRED EMBODIMENT

Reference will now be made in detail to the preferred embodiments of the present invention, examples of which are illustrated in the accompanying drawings. In describing the embodiments, parts the same with the related art will be given the same names and reference symbols.

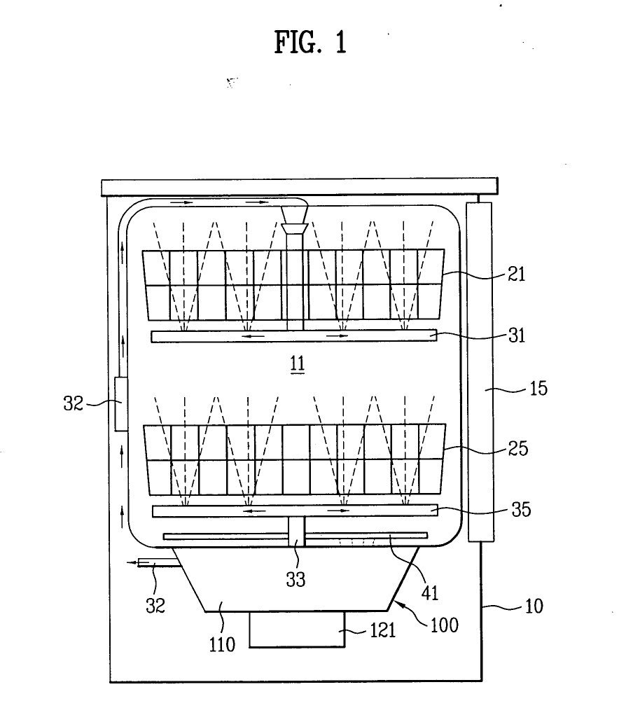

Referring to FIG. 1, there are a washing chamber 11 inside of a cabinet 10 of the dish washer, and a door 15 at one side of the cabinet 10 for opening/closing the washing chamber 11. The washing chamber 11 is provided with racks for placing dishes thereon. For reference, FIG. 1 illustrates an example in which a first rack 21 and a second rack 25 are provided in an upper portion and a lower portion of the washing chamber 11.

Also, there is at least one spray arm in the washing chamber 11 adjacent to the rack. For an example, as shown in FIG. 1, a first spray arm 31 and a second spray arm 35 are provided under the first rack 21 and the second rack 25, respectively.

The first, and second spray arms 31, and 35 are rotatably mounted, and each has a plurality of spray holes or nozzles at one side thereof. The first, and second spray arms 31, and 35 mounted thus spray high pressure washing water to the dishes on the first, and second racks 21, and 25, for washing the dishes.

For this, there is a device 100 for supplying washing water to the first spray arm 31, and the second spray arm 35 inside of the cabinet 10, for an example, under the washing chamber 11. There are a first connection pipe 32 and a second connection pipe 33 connected between the first spray arm 31 and the device 100 for supplying washing water, and the second connection pipe 33 and the device 100 for supplying washing water.

The washing water supplying device 100 supplies clean washing water from an outside to the first spray arm 31 and the second spray arm 35, at the same time, or selectively. Moreover, the washing water supplying device 100 cleans the washing water fallen from the washing chamber 11 after washing the dishes, and supplies to the first, and second spray arms 31, and 35, respectively.

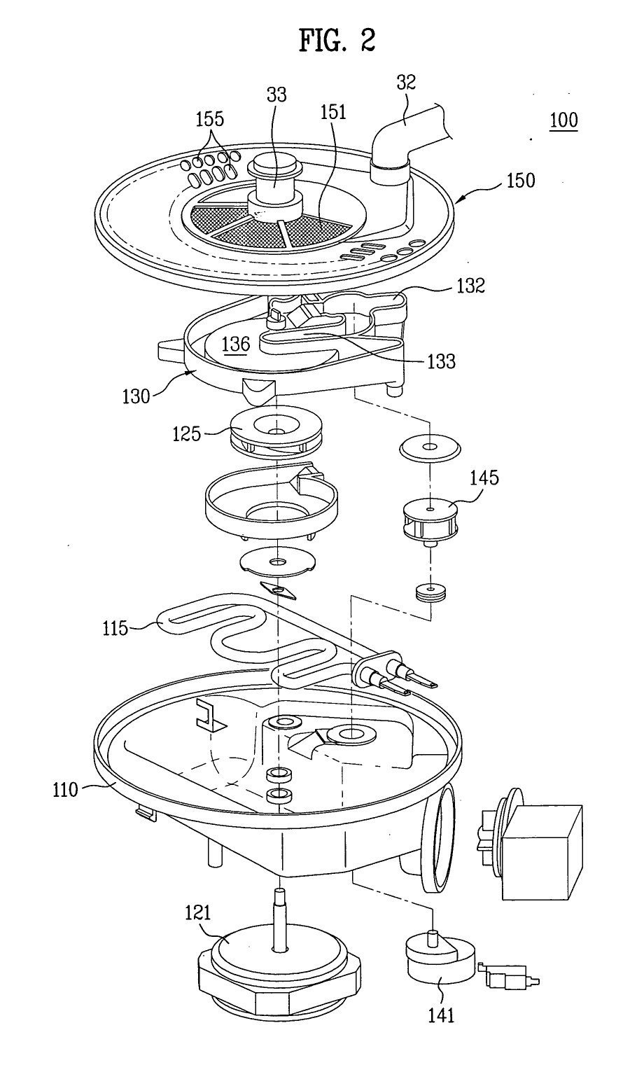

FIGS. 2˜4 illustrate one embodiment of the washing water supplying device 100 in detail, referring to which the washing water supplying device 100 will be described in more detail.

Referring to FIG. 2, the washing water supplying device 100 includes a sump 110 for holding the washing water. The sump 110 holds clean washing water received form an outside through a water supplying device (not shown), or the washing water fallen from the washing chamber after washing the dishes.

The washing water supplying device 100 also includes a pump for pumping up the washing water from the sump 110. The pump includes a pumping motor 121 under the sump 110, and an impeller 125 in the sump 110 to be rotatable by the pumping motor 121.

In the meantime, there are a heater 115 mounted on the sump 110 for heating the washing water, and a filtering housing 130 over the sump 110. Therefore, the impeller 125 is under the filtering housing 130, and the washing water pumped up from the sump 110 by the impeller 125 is supplied to the filtering housing 130.

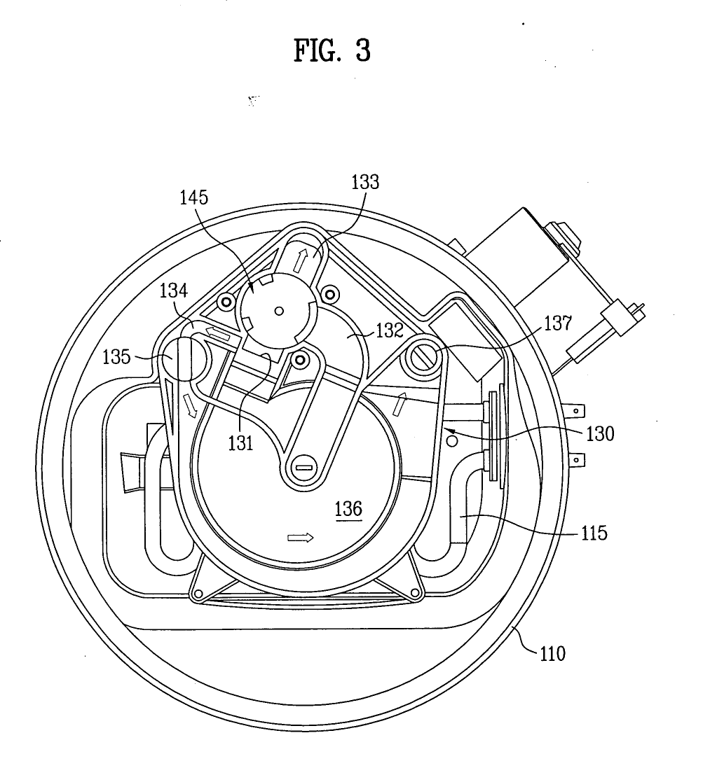

The filtering housing guides a portion of the washing water pumped up from the sump 110 to the first, and second spray arms 31, and 35, and holds rest of the washing water therein. FIG. 3 illustrates a structure of the filtering housing 130 in detail, referring to which the filtering housing 130 will be described in more detail.

Referring to FIG. 3, the filtering housing 130 has an inlet 131 at one side for the washing water from the impeller 125, and guide passages connected to the inlet 131, for an example, a first passage 132, and a second passage 133.

The first passage 132 has a first connection pipe 32 connected to the first spray arm 31, and the second passage 133 has a second connection pipe 33 connected to the second spray arm 35. Accordingly, the guide passages make the pump and the spray arms in communication.

Referring to FIG. 3, there is a flow path control valve 145 among the inlet 131, the first passage 132, and the second passage 133. The flow path control valve 145 is rotated by a control motor 141 under the sump 110, for making the inlet 131, the first passage 132, and the second passage 133 in communication, at the same time or selectively.

Therefore, the washing water, pumped up by the pump and introduced through the inlet 131, is supplied to the first spray arm 31 and the second spray arm 35 at the same time, or to one of them, selectively.

In the meantime, the filtering housing 130 also has a contaminated water chamber 136 therein for holding rest of washing water introduced through the inlet 131 after the washing water is introduced into the first passage 132, and the second passage 133. For this, a third passage 134 is provided to connect the inlet 131 to the contaminated water chamber 136.

The third passage 134 has a sensor 135 for measuring a level of contamination of the washing water being introduced into the contaminated water chamber 136. The sensor 135 has a light emitting portion (not shown) and a light receiving portion (not shown), for determining the level of contamination based on a quantity of light received at the light receiving portion.

There is a drain 137 at one side of the contaminated water chamber 136 spaced a distance away from the inlet 131. Therefore, if a drain motor (not shown) works, the washing water held in the contaminated water chamber 136 is drained from the contaminated water chamber 136 to outside of the dishwasher.

However, if the drain motor does not work, the contaminated water chamber 136 keeps receiving the washing water through the inlet 131. Accordingly, if a water level of the washing water becomes higher than the contaminated water chamber 136, the washing water overflows from the contaminated water chamber 136, and drops down to the sump 110.

In the meantime, the washing water introduced into the contaminated water chamber 136 contains contaminants formed during washing of the dishes. Therefore, the present invention suggests providing a member for filtering the contaminants contained in the washing water overflowing from the contaminated water chamber 136. For this, there is a filtering panel 150 on the filtering housing 130 of the contaminated water chamber 136.

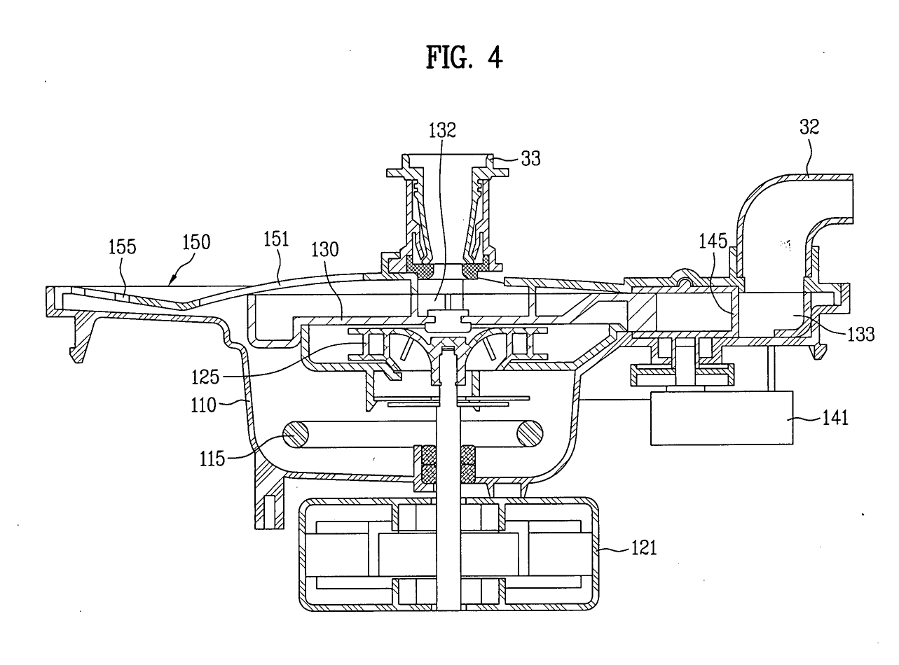

Referring to FIG. 4, the filtering panel 150, for an example, of a circular form has a central portion covering an upper portion of the contaminated water chamber 136. As shown in FIG. 2, the filtering panel 150 is provided with at least one first filter 151 at the central portion.

For reference, in FIG. 2, the first filter 151 is a net of small mesh. However, the first filter 151 is not limited to this, and any structure is adequate as the first filter 151 as far as the structure can filter small contaminants and passes the washing water, such as a perforated plate.

In the meantime, as shown in FIG. 4, a peripheral portion of the filtering panel 150 covers a portion of an upper surface of the sump 110. The peripheral portion has at least one aperture 155 making an inside of the sump 110 and an upper portion of the filtering panel 150 in communication.

The aperture 155 guides contaminated washing water dropped down after washing the dishes in the washing chamber 11 to the sump 110. Since the aperture 155 is not for filtering the contaminants the washing water, it is preferable that a size of the aperture 155 is large adequately.

Above structure enables filtering of the contaminants from the washing water overflowed from the contaminated water chamber 136 at the first filter 151. However, contaminants failed to pass the first filter 151 in this process remain in the contaminated chamber 136, and block the mesh of the first filter 151.

Therefore, for preventing this, as shown in FIG. 1, the dish washer of the present invention is further provided with a third spray arm 41. The third spray arm 41, over the washing water supplying device 100, sprays high pressure water toward the first filter 151, for preventing the contaminants from blocking the mesh of the first filter 151.

In the meantime, the washing water passed through, and cleaned at the first filter 151 passes through the aperture 155 and held in the sump 110.

The operation of the dish washer of the present invention will be described.

Upon putting the dish washer into operation, clean washing water is supplied to the sump 110. When the pumping motor 121 comes into operation, the impeller 125 rotates, to introduce the washing water from the sump 110 to the inlet 131 of the filtering housing 130.

A portion of the washing water introduced through the inlet 131 is guided to the first passage 132 and the second passage 133 by the flow path control valve 145, at the same time or selectively. According to this, the first spray arm 31 and the second spray arm 35 spray the washing water, at the same time, or individually, to wash the dishes on the first and/or second racks 21, and 25.

The contaminated washing water having washed the dishes at the washing chamber 11 drops on the filtering panel 150, passes the aperture 155, and held in the sump 110. According to this, the sump 110 also holds the contaminants formed during washing of the dishes, together with the washing water.

On the other hand, rest of the washing water introduced through the inlet 131 of the filtering housing 130 after pumped up from the sump 110 is introduced into the contaminated water chamber 136 through the third passage 134.

In this instance, the sensor 135 measures the level of contamination of the washing water being introduced into the flow water chamber 136, and transfers to the control portion (not shown). If the washing water is contaminated heavily, the control portion operates the drain motor, for draining the washing water from the contaminated water chamber 136 to an outside of the dish washer. Opposite to this, if the contamination is not heavy, the control portion does not operate the drain motor, to hold the washing water introduced into the third passage 134 in the contaminated water chamber 136.

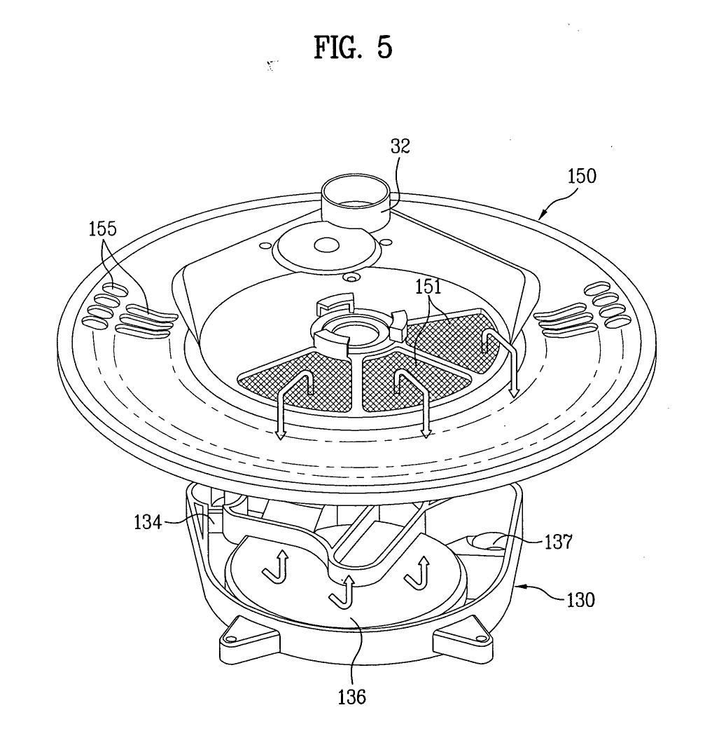

If there is much water introduced into the contaminated water chamber 136, the washing water overflows from the contaminated water chamber 136. In this instance, as shown in FIG. 5, the first filter 151 of the filtering panel 150 filters the contaminants from the washing water. Therefore, cleaned water is introduced into the sump 110 through the aperture 155, and contaminants failed to pass the first filter 151 remains in the contaminated water chamber 136.

Thus, the dish washer of the present invention filters only the washing water that is pumped up by the pump, and introduced into the contaminated water chamber 136 through the third passage 134. According to this, it seems that only a portion of the washing water is filtered. However, an effect that almost all the washing water is filtered can be obtained.

According to this, the dish washer of the present invention can filter the washing water effectively, and supply to the first, and second spray arms. Moreover, the washing water can be filtered and used continuously, to enable to use an amount of the washing water less than the related art in washing the dishes.

However, despite of above advantages, the dish washer of the present invention described with reference to FIGS. 1˜4 has the following a few problems, still.

First, for improving a filtering performance, a net with small mesh is used as the first filter 151. In this case, even if the filtering performance of the dish washer is improved, the filtering performance of the first filter 151 drops as an operation time period of the dish washer passes by because the mesh of the first filter 151 is susceptible to be blocked by the contaminants in the washing water.

Second, a water pressure of the contaminated water chamber 136 increases once the contaminants block the mesh of the first filter 151. According to this, as a pressure acting on the filter 151 also increases, the first filter 151 is liable to deform.

Third, the increase of the pressure of the contaminated water chamber 136 also drains the washing water from the contaminated water chamber 136, and to introduce washing water newly from an outside, resulting in waste of the washing water.

Fourth, the increased water pressure of the contaminated water chamber 136 may cause back flow of the washing water from the contaminated water chamber 136 to the third passage 134 and the inlet 131. In this case, the sensor 135 is liable to fail correct measurement of the level of the contamination, such that the control portion operates the drain motor, then a large amount of washing water is wasted.

Accordingly, the present invention suggests providing a device for supplying washing water in a dish washer of an improved structure that can solve above problems. The device for supplying washing water of the improved structure enables an effective prevention of increase of the pressure acting on the first filter 151 when the washing water overflows from the contaminated water chamber 136, thereby improving a performance of washing water filtering.

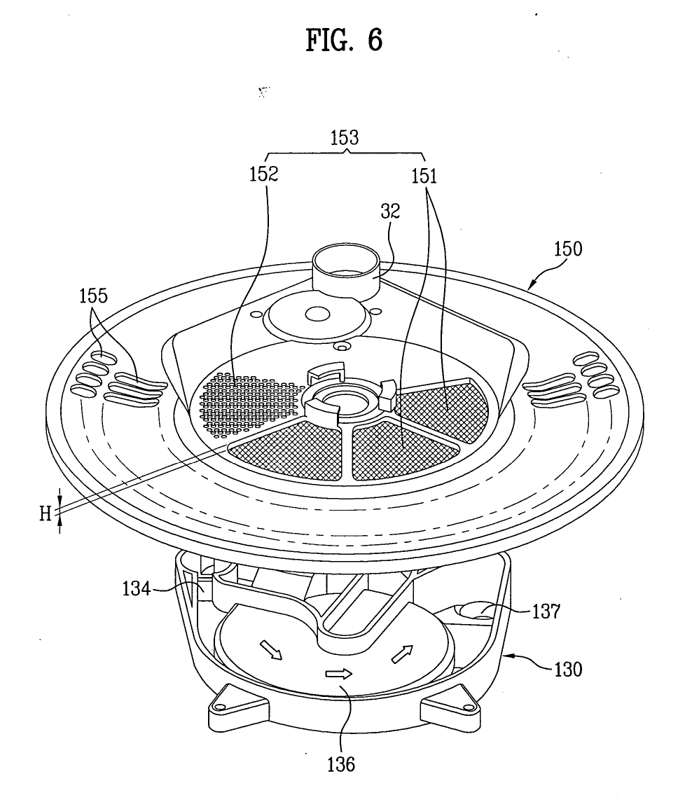

The device for supplying washing water of such an improved is illustrated in FIGS. 6˜8, referring to which the device will be described in more detail. For reference, in describing the embodiment, parts identical to ones described with reference to FIGS. 2˜5 will be given the same names and reference symbols, and repetitive description of which will also omitted.

FIG. 6 illustrates a disassembled perspective view of a filtering panel, and a filtering housing of an improved structure. As can be noted from FIG. 6, in the embodiment, the filtering panel 150 has a filter portion 153 for filtering the washing water. Different from the embodiment described with reference to FIGS. 2˜5, the filter portion 153 includes at least two filters, for an example, a first filter 151 and a second filter 152, having filtering capabilities different from each other. Of course, the filter portion 153 may include more number of filters having filtering capabilities different from one another.

Referring to FIG. 6, the first filter 151, and the second filter 152 are placed on the filtering housing 130, more specifically, on the contaminated water chamber 136. In this instance, though the first filter 151 has one large sized body, as shown FIG. 6, it is preferable that the first filter 151 has a plurality of small bodies for better endurance to a high water pressure.

The filter portion 153 may be a net or a perforated portion. For reference, in FIG. 6, an embodiment in which the first filter 151 is the net, and the second filter 152 is the perforated portion is illustrated. However, configuration of the filter portion 153 is not limited to this, but it does not matter even if the first filter 151 is the perforated portion and the second filter 152 is the net. Of course, both of them may be the same material.

In the meantime, the second filter 152 is coarser than the first filter 151. That is, the aperture of the second filter 152 is greater than the aperture of the first filter 151.

This structure enables the washing water to escape through the second filter 152 even if the apertures or mesh are blocked by the contaminants. According to this, the operation time of the dish washer increases, to prevent drop of the filtering capability of the filter portion 153.

Referring to FIG. 6, it is preferable that the first filter 151 is arranged adjacent to the drain 137, and the second filter 152 is arranged adjacent to the inlet 131, because of the following reasons.

As described before, the washing water introduced into the filtering housing 130 through the inlet 131 is held in the contaminated water chamber 136 through the third passage 134, the drain 137 is provided at one side of the contaminated water chamber 136 far from the inlet 131.

Therefore, it may be called that the inlet 131 side is an upstream of the washing water, and the drain 137 side is a downstream of the washing water. During operation of the dish washer, the contaminants in the washing water accumulates at the downstream side rather than at the upstream side.

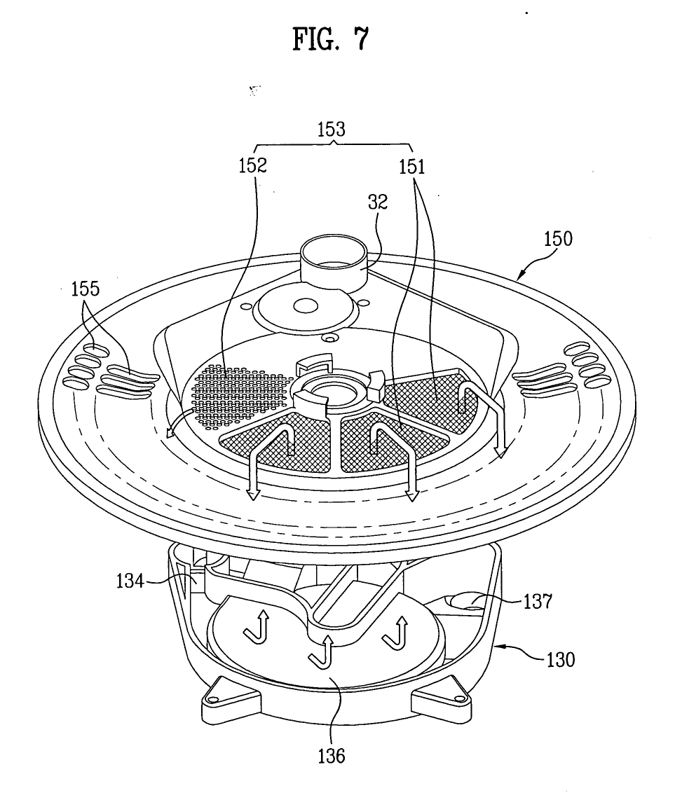

Therefore, referring to FIG. 7, at the initial stage of operation of the dish washer, the first filter 151 having better filtering performance at the downstream side much contaminant accumulates thereon filters the washing water, normally. Of course, the second filter 152 also filters comparatively large sized contaminants.

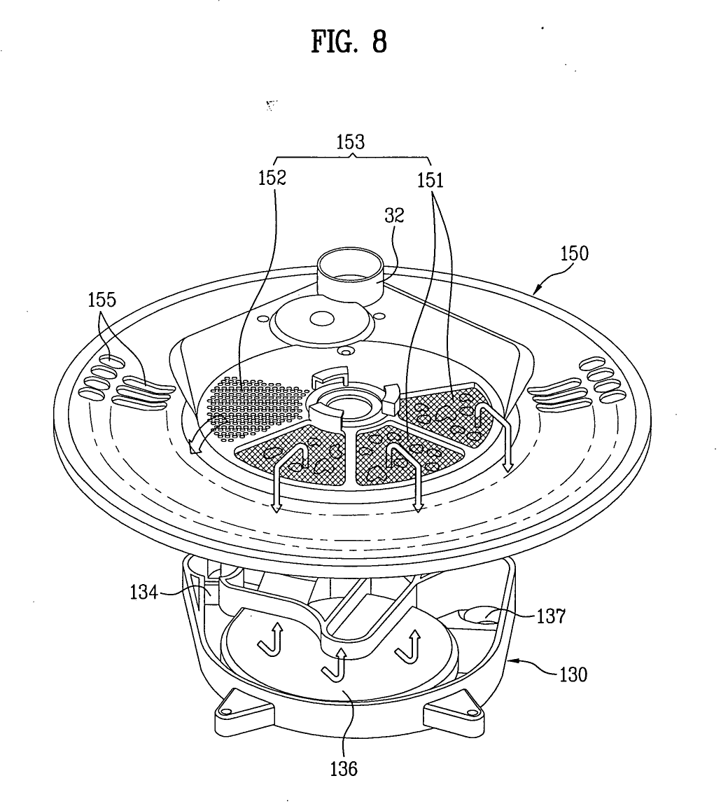

Then, as time goes by, if the first filter 151 is blocked as substantial portion of the contaminants are filtered from the washing water, as shown in FIG. 8, a large amount of washing water is discharged to an outside of the contaminated water chamber 136 through the second filter 152 at the upstream.

According to this, operating of the drain motor caused by sudden increase of the water pressure in the contaminated water chamber 136 coming from blocking of the first filter 151 can be prevented. After, the first filter 151 loses the filtering function, the second filter 152 keeps filtering comparatively large contaminants from the washing water. According to this, an effect that the filtering performance of the filter portion is improved can be obtained.

In the meantime, in the filter portion 153, it is preferable that the second filter 152 is arranged at a position higher than the first filter 151. For reference, FIG. 6 illustrates an example in which the second filter 152 is arranged at a position higher than the first filter 151 by “H”. This structure enables to prevent drop of filtering performance more because a major portion of the washing water passes through, and filtered at the first filter 151 as far as the first filter 151 performs normally.

Above washing water supply device of an improved structure, not only prevents the increase of the water pressure in the contaminated water chamber, but also improves the filtering performance of the filter portion. Therefore, the dishes can be cleaned by using a small amount of water. Moreover, deformation of the filter caused by the high pressure can be prevented, and back flow of the washing water from the contaminated water chamber 136 can be prevented effectively, to prevent waste of the washing water coming from malfunction of the sensor 135.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A device for supplying washing water to a dish washer comprising:
a sump for holding washing water;
a filtering housing for guiding a portion of the washing water pumped up by a pump from the sump to a spray arm in a washing chamber, and holding rest of the washing water therein; and
a filtering panel including;
a filter portion for filtering the washing water overflowed from the filtering housing by using at least two filters having filtering capabilities different from each other, and
apertures for guiding the washing water dropped after washing the dishes in the washing chamber, or passed through the filter portion.

2. The device as claimed in claim 1, wherein the filtering housing includes;
a guide passage for making the pump and the spray arm in communication, and
a contaminated water chamber in communication with the pump, for holding the rest portion of the washing water.

3. The device as claimed in claim 1, wherein the filtering panel covers an upper portion of the filtering housing.

4. The device as claimed in claim 1, wherein the filter portion includes;
at least one first filter on the filtering housing, and
a second filter on the filtering housing which is coarser than the first filter.

5. The device as claimed in claim 4, wherein the contaminated water chamber includes;
an inlet being through which the washing water is introduced into an inside of the contaminated water chamber; and
a drain for draining the washing water from the contaminated water chamber selectively.

6. The device as claimed in claim 5, wherein the first filter is arranged adjacent to the drain.

7. The device as claimed in claim 5, wherein the second filter is arranged adjacent to the inlet.

8. The device as claimed in claim 4, wherein the second filter is arranged at a position higher than the first filter.

9. The device as claimed in claim 1, wherein the filer portion includes at least one of a net and a perforated portion.

10. The device as claimed in claim 4, wherein the second filter includes a perforated portion formed in the filtering panel.

11. A dish washer comprising:
a cabinet having a washing chamber therein;
at least a spray arm for spraying high pressure washing water to dishes in the washing chamber; and
a device for supplying washing water to a dish washer including;
a sump for holding washing water, a filtering housing for guiding a portion of the washing water pumped up by a pump from the sump to a spray arm in a washing chamber, and holding rest of the washing water therein, and a filtering panel including a filter portion for filtering the washing water overflowed from the filtering housing by using at least two filters having filtering capabilities different from each other, and apertures for guiding the washing water dropped after washing the dishes in the washing chamber, or passed through the filter portion.

12. The dish washer as claimed in claim 11, wherein the filtering housing includes;
a guide passage for making the pump and the spray arm in communication, and
a contaminated water chamber in communication with the pump, for holding the rest portion of the washing water.

13. The dish washer as claimed in claim 11, wherein the filtering panel covers an upper portion of the filtering housing.

14. The dish washer as claimed in claim 11, wherein the filter portion includes;
at least one first filter on the filtering housing, and
a second filter on the filtering housing which is coarser than the first filter.

15. The device as claimed in claim 14, wherein the contaminated water chamber includes;
an inlet being through which the washing water is introduced into an inside of the contaminated water chamber; and
a drain for draining the washing water from the filtering housing selectively.

16. The dish washer as claimed in claim 15, wherein the first filter is arranged adjacent to the drain.

17. The dish washer as claimed in claim 15, wherein the second filter is arranged adjacent to the inlet.

18. The dish washer as claimed in claim 14, wherein the second filter is arranged at a position higher than the first filter.

19. The dish washer as claimed in claim 11, wherein the filer portion includes at least one of a net and a perforated portion.

20. The dish washer as claimed in claim 14, wherein the second filter includes a perforated portion formed in the filtering panel.
